(19) United States
(12) Patent Application Publication
(10) Pub. No.: US 2017/0018879 A1
(43) Pub. Date: Jan. 19, 2017

(54) Frame Module

(71) Applicant: COMPAL BROADBAND NETWORKS INC., Taipei City (TW)

(72) Inventors: Chiang-Chang Wu, Hsinchu County (TW); Cheng-Shan Lin, Hsinchu County (TW); Chung-Ming Pan, Hsinchu County (TW)

(21) Appl. No.: 15/044,124

(22) Filed: Feb. 16, 2016

Related U.S. Application Data
(60) Provisional application No. 62/193,099, filed on Jul. 16, 2015.

(30) Foreign Application Priority Data
Dec. 3, 2015 (TW) 104219408

(51) Int. Cl. H01R 13/646; H01R 33/94

(52) U.S. Cl. CPC H01R 13/646; H01R 33/94

(57) ABSTRACT

A frame module for an electronic device includes a plurality of brackets and a shield element. A connector for transmitting a radio-frequency signal is formed between two of the plurality of brackets. The shield element is fixed with the two of the plurality of brackets via riveting, wherein a hole is formed in the shield element, and the connector is placed in the hole to fix the connector after the shield element is fixed with the two of the plurality of brackets via riveting.

### CROSS REFERENCE TO RELATED APPLICATIONS

This application claims the benefit of U.S. provisional application No. 62/193,099, filed on Jul. 16, 2015 and incorporated herein by reference.

### BACKGROUND OF THE INVENTION

1. Field of the Invention

The present invention relates to a frame module, and more particularly, to a frame module having a connector being fixed via riveting only or via both riveting and metal welding.

2. Description of the Prior Art

Cable electronic products such as cable modem and cable television set-top box are designed with a radio-frequency (RF) connector, hereinafter called F-connector, wherein the F-connector is used for connecting the cable with the cable modem or cable television set-top box to transmit radio-frequency signals. In addition, considering aesthetic design, the comfort of user and interior decoration of house and working environments, many cable electronic products are designed with chic and smooth appearances, thereby the design of the F-connector becomes more flexible in order to adapt to the chic and smooth appearances.

The electromagnetic susceptibility of the cable electronic products is important in evaluating the communication quality of the cable electronic products. Further, transmission of the radio-frequency signals is influenced by the firmness of the F-connector. Poor firmness of the F-connector can cause contact failure between the F-connector and the cable, which leads to bad communication quality of the cable electronic products.

Therefore, how to firmly fix the F-connector on the cable electronic products to ensure the communication quality has become a crucial issue in the industry.

### SUMMARY OF THE INVENTION

It is therefore an objective of the present invention to provide a frame module having a connector being firmly fixed with an electronic device to ensure communication quality.

The present invention a frame module frame module for an electronic device includes a plurality of brackets and a shield element. A connector for transmitting a radio-frequency signal is formed between two of the plurality of brackets. The shield element is fixed with the two of the plurality of brackets via riveting, wherein a hole is formed in the shield element, and the connector is placed in the hole to fix the connector after the shield element is fixed with the two of the plurality of brackets via riveting.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an isotropic view from a first direction of a frame module according to an embodiment of the present invention.

FIG. 2 illustrates an isotropic view from the first direction of a frame module according to another embodiment of the present invention.

FIG. 3 illustrates an isotropic view from a second direction of the frame module in FIG. 2 according to an embodiment of the present invention.

### DETAILED DESCRIPTION

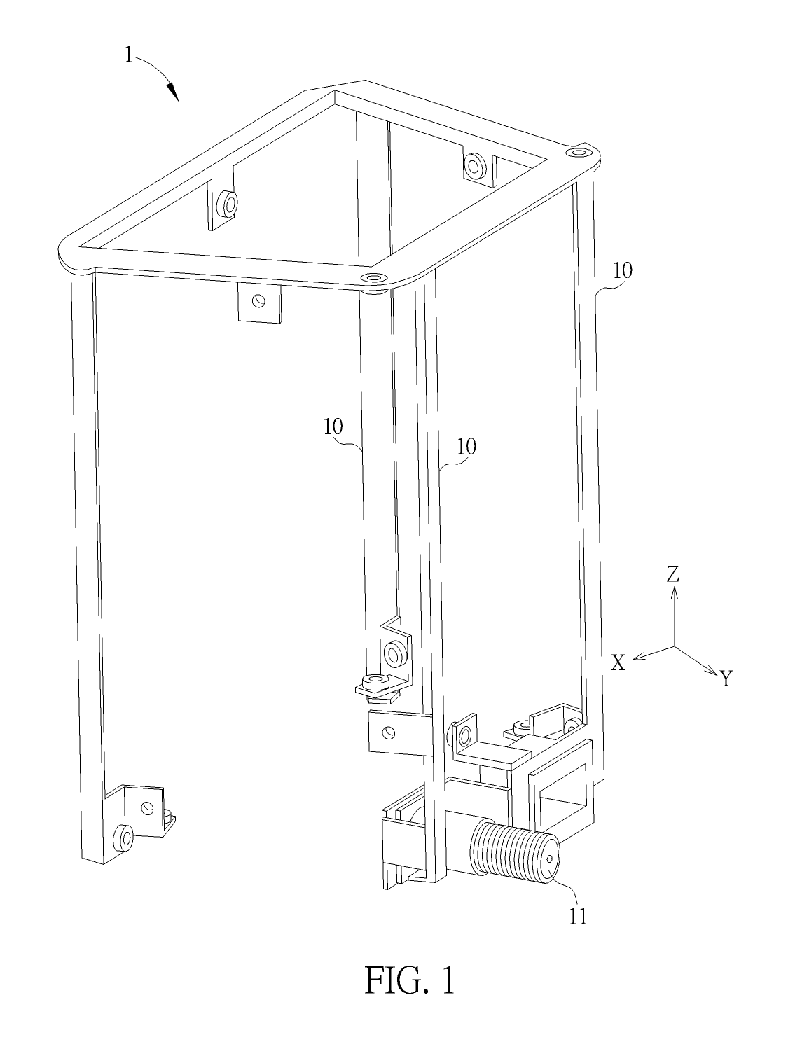

FIG. 1 illustrates an isotropic view from a first direction (i.e., an opposite of Y-direction) of a frame module 1 according to an embodiment of the present invention. The frame module 1 is utilized in cable electronic products such as a cable modem and a cable television set-top box. The frame module 1 is a framework for combining with or containing functional assembly parts and sub-modules. The frame module 1 includes a plurality of vertical brackets 10 extending in parallel to Z-direction and a connector 11. The connector 11 is formed between two of the vertical brackets 10. In this embodiment, the connector 11 can be a radio-frequency connector (hereinafter called F-connector) for connecting a cable with the cable modem or the cable television set-top box. The connector 11 and the vertical brackets 10 can be formed in one piece, or the connector 11 can be fixed with the vertical brackets 10 via metal welding.

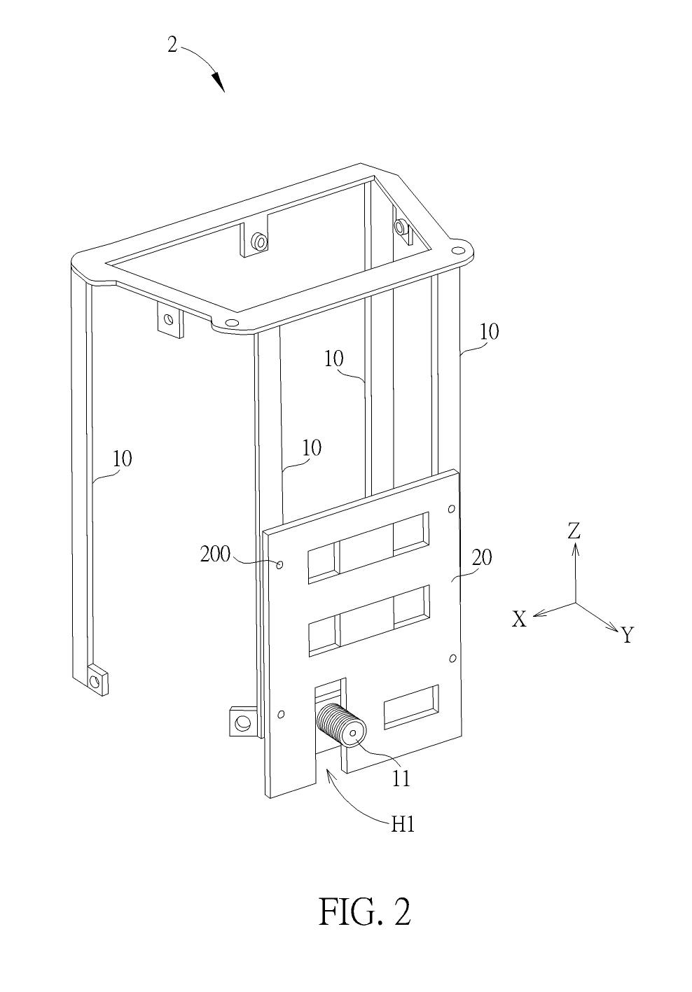

FIG. 2 illustrates an isotropic view from the first direction of a frame module 2 according to another embodiment of the present invention. The frame module 2 includes the plurality of vertical brackets 10, the connector 11 and a shield element 20. The shield element 20 is fixed with the vertical brackets 10 via riveting. Specifically, a plurality of riveted joints 200 can be formed in the vertical brackets 10 and the shield element 20 in advance, and the vertical brackets 10 and shield element 20 can be fixed together after rivets are installed in the riveted joints 200. The length of the rivet shaft should be greater than a summation of thicknesses of vertical brackets 10 and the shield element 20, such that the tail of the rivet shaft can be deformed with a hammer or rivet gun to rivet the vertical brackets 10 and the shield element 20, or the tail of the rivet shaft can be welded to the vertical brackets 10 (or the shield element 20). In one embodiment, after the shield element 20 is fixed with the vertical brackets 10 via riveting, metal welding or soldering can be further applied to enhance the firmness between the shield element 20 and the vertical brackets 10.

The shield element 20 is formed with a hole H1, wherein the connector 11 is placed in the hole H1 after the shield element 20 is fixed with the vertical brackets 10 via riveting. During installation for cable assembly of the cable electronic products, an external force for screwing the cable in the connector 11 can cause twisting and displacement to the connector 11, which leads to contact failure between the connector 11 and the cable. Therefore, placing the connector 11 in the hole H1 prevents the connector 11 from twisting due to the external force, so as to ensure the firmness of the connector 11. Moreover, the shield element 20 can be made of materials such as hard metal capable of electromagnetic shielding, which prevents the radio-frequency signals transmitted by the cable from electromagnetic interferences, so as to ensure communication quality.

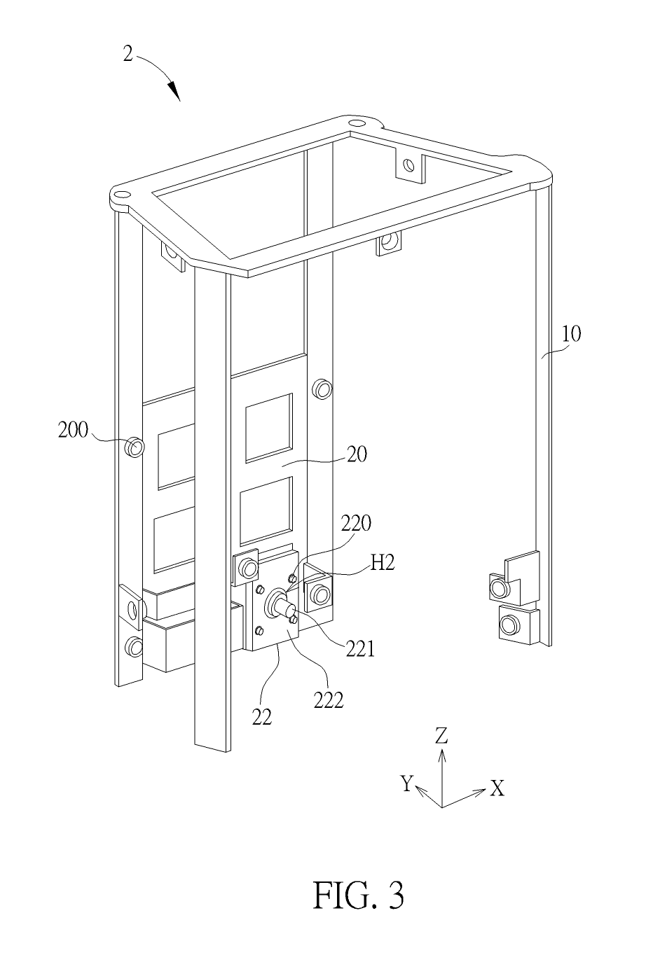

FIG. 3 illustrates an isotropic view from a second direction (i.e., Y-direction) of the frame module 2 according to another embodiment of the present invention. The frame module 2 further includes an adaptor 22 fixed with the connector 11 and the shield element 20 via riveting. The adaptor 22 includes a plug 221 and a cover board 222. The plug 221 is coupled to the connector 11 for receiving the radio-frequency signals from the connector 11. The cover board 222 is fixed with the shield element 20 via riveting. Specifically, a plurality of riveted joints 220 can be formed in the cover board 222 and the shield element 20 in advance, and the cover board 222 and the shield element 20 can be fixed together after the rivets are installed in the riveted joints 220. In one embodiment, after the cover board 222 of the adaptor 22 is fixed with the shield element 20 via riveting, the cover board 222 is fixed with the connector 11 and the shield element 20 via metal welding or soldering to enhance the firmness between the cover board 222 and the shield element 20.

The cover board 222 is formed with a hole H2, wherein the plug 221 is placed in the hole H2 after the cover board 222 is fixed with the shield element 20. During installation, placing the plug 221 in the hole H2 is benefit for alignment with the connector 11, which prevents the cable from contact failure and improves installation convenience. In addition, the cover board 222 can be made of hard metal materials or nonmetallic materials. The cover board 222 is capable of electromagnetic shield if metal materials are used, which prevents the radio-frequency signal transmitted by the cable from electromagnetic interferences to ensure communication quality.

To sum up, the present invention applies riveting only or both riveting and metal welding (or soldering) to fix the connector and the adaptor with the frame module to ensure the firmness of the connector the adaptor, so as to ensure communication quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A frame module for an electronic device, comprising
a plurality of vertical brackets, wherein a connector for transmitting a radio-frequency signal is formed between two of the plurality of brackets; and
a shield element fixed with the plurality of vertical brackets via riveting;
wherein the shield element is formed with a first hole, wherein the connector is placed in the first hole after the shield element is fixed with the plurality of vertical brackets.

2. The frame module of claim 1, wherein the connector and the plurality of vertical brackets are formed in one piece or the connector is fixed on the plurality of vertical brackets via metal welding.

3. The frame module of claim 1, wherein the shield element is fixed with the two of the plurality of brackets via riveting.

4. The frame module of claim 3, wherein the shield element is fixed on the plurality of vertical brackets via metal welding or soldering after the shield element is fixed on the plurality of vertical brackets via riveting.

5. The frame module of claim 1, further comprising an adaptor fixed with the connector and the shield element via riveting.

6. The frame module of claim 5, wherein after the cover board of the adaptor is fixed with the connector and the shield element via riveting, the adaptor is fixed with the connector and the shield element via metal welding or soldering.

7. The frame module of claim 5, wherein the adaptor comprises:
a plug coupled to the connector for receiving the radio-frequency signal from the connector; and
a cover board fixed with the shield element via riveting;
wherein the cover board is formed with a second hole, wherein the plug is placed in the second hole after the cover board is fixed with the shield element via riveting.

8. The frame module of claim 1, wherein the connector is an F-connector.

9. The frame module of claim 1, wherein the electronic device is a cable modem or a cable television set-top box.
